(19) United States
(12) Patent Application Publication
(10) Pub. No.: US 2020/0202221 A1
(43) Pub. Date: Jun. 25, 2020

(54) FAULT DETECTION METHOD AND SYSTEM BASED ON GENERATIVE ADVERSARIAL NETWORK AND COMPUTER PROGRAM

(71) Applicant: Shandong University of Science and Technology, Qingdao (CN)

(72) Inventors: Youqing WANG, Qingdao (CN); Xiaoxiao ZHANG, Qingdao (CN); Donghua ZHOU, Qingdao (CN); Maiying ZHONG, Qingdao (CN)

(21) Appl. No.: 16/720,966

(22) Filed: Dec. 19, 2019

(30) Foreign Application Priority Data
Dec. 20, 2018 (CN) 201811559144.5

(51) Int. Cl. G06N 3/08; G06N 3/04

(52) U.S. Cl. CPC G06N 3/088; G06N 3/0454

(57) ABSTRACT

The present invention belongs to the field of digital information transmission technologies and discloses a fault detection method and system based on a generative adversarial network and a computer program. The fault detection method includes collecting samples and adding labels for the samples. A generative adversarial network is then trained to generate virtual fault samples, where the number of the generated virtual fault samples is equal to a difference between the number of normal samples and the number of fault sample. The virtual fault samples are added to the actually collected samples to obtain a new training data set. A classifier is then trained based on the new training data set, and fault detection and diagnosis is conducted using the trained classifier.

### TECHNICAL FIELD

The present invention belongs to the field of digital information transmission technologies, and in particular, to a fault detection method and system based on a generative adversarial network and a computer program.

### BACKGROUND

Currently, in the prior art, there exists a challenge of sample imbalance in existing supervised fault detection methods, that is, there are obviously more normal samples than fault samples. As an unsupervised learning method, a generative adversarial network can be used to autonomously learn a law of fault samples and generate virtual fault samples, to balance the numbers of normal samples and fault samples. In most cases, fault samples are far less than normal samples, and therefore there exists sample imbalance. All existing supervised fault detection methods (such as a support vector machine and a neural network) are essentially binary classifiers. The optimal classification vector (or a network weight) can be found only when the numbers of the two types of labeled samples are balanced. During binary classification, if there is number imbalance between normal samples and fault samples in a training data set, a classification result is inaccurate.

In case of sample imbalance, an obtained classification vector (or a network weight) is not the optimal solution. Therefore, the fault detection effect is greatly affected and the problem of sample imbalance often occurs. If a sample imbalance ratio exceeds 4:1, a classifier cannot satisfy the classification requirement to a great extent due to data imbalance. Therefore, it is necessary to deal with the classification imbalance problem before establishing a classification model, to reduce a false positive rate and a failed reporting rate.

To sum up, a problem existing in the prior art is as follows: In case of sample imbalance, the fault detection effect of the existing supervised fault detection method (such as a support vector machine and a neural network) is greatly affected.

There are the following difficulty and significance in resolving the foregoing technical problem: Sample imbalance is a universal phenomenon in the fault detection field, which is serious problem that troubles the engineering technical personnel in the field. In case of sample imbalance, whether it is possible to further supplement data (there must be a small type of sample data) should be first considered, because more data usually results in higher classification accuracy. Moreover, a generative adversarial network can be used to learn a statistical law of fault samples and autonomously generate fault samples, to balance the numbers of fault samples and normal samples. The present invention provides a framework with high universality and good inclusivity, which can be combined with any supervised fault detection method. Therefore, this framework is expected to be widely used in many fields.

### SUMMARY

In view of the problem existing in the prior art, the present invention provides a fault detection method and system based on a generative adversarial network and a computer program.

The present invention is achieved by the following technical solutions: A fault detection method based on a generative adversarial network, where in the fault detection method based on a generative adversarial network, the generative adversarial network is first used to learn a statistical law of fault samples and autonomously generate fault samples, to balance the numbers of fault samples and normal samples; and then a conventional supervised fault detection method is used for learning and modeling of new samples.

Further, the fault detection method based on a generative adversarial network includes:

step 1: collecting samples and adding labels for the samples;

step 2: training a generative adversarial network to generate virtual fault samples;

step 3: generating virtual fault samples by using a trained generative adversarial network, where the number of the generated virtual fault samples is equal to a difference between the number of normal samples and the number of fault samples;

step 4: adding the virtual fault samples to the actually collected samples to obtain a new training data set;

step 5: training a classifier based on the new training data set; and

step 6: conducting fault detection and diagnosis by using a trained classifier.

Further, in step 2, fault samples are used as network input; a generative model is used to generate virtual fault samples; a discrimination model is used to distinguish an authentic fault sample and a virtual fault sample; and when an error probability of the discrimination model reaches 0.5, a training process ends.

Another objective of the present invention is to provide a fault detection system based on a generative adversarial network for implementing the fault detection method based on a generative adversarial network, where the fault detection system based on a generative adversarial network includes:

a sample collection module, configured to collect samples and add labels for the samples;

a training module, configured to train a generative adversarial network to generate virtual fault samples;

a virtual fault sample module, configured to generate virtual fault samples by using a trained generative adversarial network; a training data set module, configured to add the virtual fault samples to the actually collected samples to obtain a new training data set;

a classifier training module, configured to train a classifier based on the new training data set; and

a detection and diagnosis module, configured to conduct fault detection and diagnosis on a trained classifier.

Another objective of the present invention is to provide a computer program for implementing the fault detection method based on a generative adversarial network.

Another objective of the present invention is to provide an information data processing terminal for implementing the fault detection method based on a generative adversarial network.

Another objective of the present invention is to provide a computer readable storage medium, including an instruction, where when the instruction is run on a computer, the computer is enabled to implement the fault detection method based on a generative adversarial network.

Based on the description mentioned above, advantages and positive effects of the present invention are as follows: In the invention patent, a generative adversarial network is first used to learn a statistical law of fault samples and autonomously generate fault samples, to balance the numbers of fault samples and normal samples. Then, a conventional supervised fault detection method (such as a support vector machine and a neural network) can be used for learning and modeling of new samples, to obtain a better fault detection model. In this experiment, normal data and tooth missing fault data of a rotary machine are selected. A firs group is normal data including 21 normal samples and 3 fault samples. Accuracy of classification using a BP neural network is 0.7500. A second group includes normal data and virtual fault data that is generated by using a generative adversarial network, in which there are 12 normal samples, 6 fault samples, and 6 virtual fault samples. Accuracy of classification using a BP neural network is 0.9583.

### BRIEF DESCRIPTION OF THE DRAWINGS

FIG. 1 is a flowchart of a fault detection method based on a generative adversarial network according to an embodiment of the present invention; and

FIG. 2 is a schematic structural diagram of a fault detection system based on a generative adversarial network according to an embodiment of the present invention.

In the figures: 1—sample collection module; 2—training module; 3—virtual fault sample module; 4—training data set module; 5—classifier training module; and 6—detection and diagnosis module.

### DETAILED DESCRIPTION

To make the objectives, technical solutions, and advantages of the present invention clearer and more understandable, the following describes the present invention in more details with reference to embodiments. It should be understood that the embodiments described herein are merely intended to explain the present invention, rather than to limit the present invention.

In view of a problem that the fault detection effect of an existing supervised fault detection method is greatly affected in case of sample imbalance, in the invention patent, a generative adversarial network is first used to learn a statistical law of fault samples and autonomously generate fault samples, to balance the numbers of fault samples and normal samples. Then, a conventional supervised fault detection method can be used for learning and modeling of new samples, to obtain a better fault detection model.

The present invention will be explained in detail below with reference to the accompanying drawings.

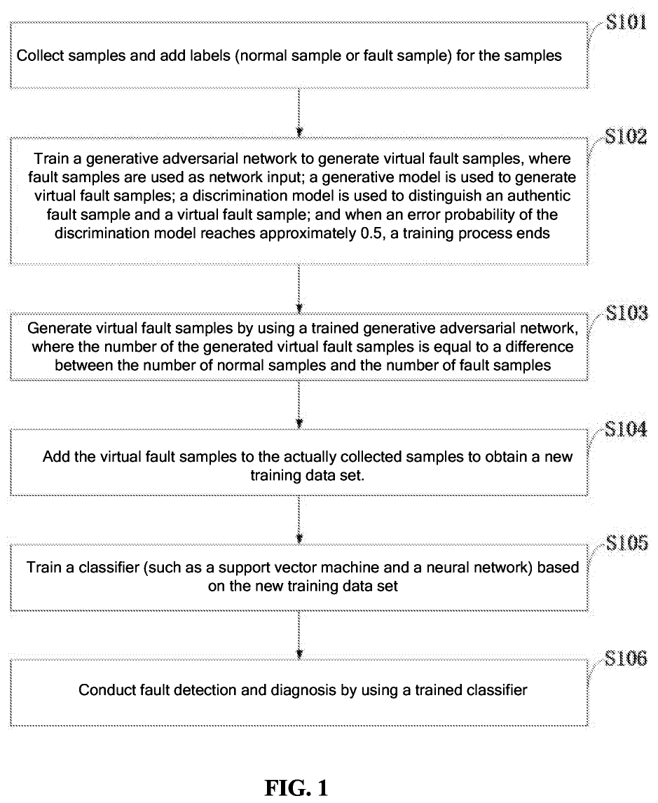

As shown in FIG. 1, a fault detection method based on a generative adversarial network provided in an embodiment of the present invention includes:

S101: Collect samples and add labels (normal sample or fault sample) for the samples.

S102: Train a generative adversarial network to generate virtual fault samples, where fault samples are used as network input; a generative model is used to generate virtual fault samples; a discrimination model is used to distinguish an authentic fault sample and a virtual fault sample; and when an error probability of the discrimination model reaches approximately 0.5, a training process ends.

S103: Generate virtual fault samples by using a trained generative adversarial network, where the number of the generated virtual fault samples is equal to a difference between the number of normal samples and the number of fault samples.

S104: Add the virtual fault samples to the actually collected samples to obtain a new training data set.

S105: Train a classifier (such as a support vector machine and a neural network) based on the new training data set.

S106: Conduct fault detection and diagnosis by using a trained classifier.

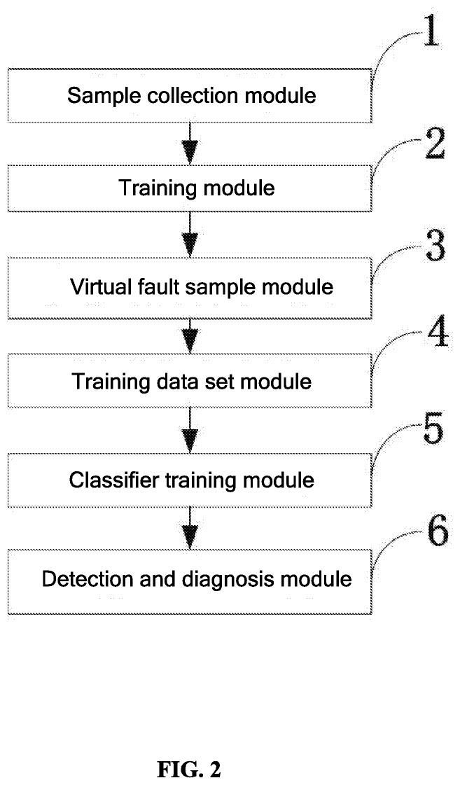

As shown in FIG. 2, a fault detection system based on a generative adversarial network provided in an embodiment of the present invention includes modules as follow:

a sample collection module 1, configured to collect samples and add labels for the samples;

a training module 2, configured to train a generative adversarial network to generate virtual fault samples;

a virtual fault sample module 3, configured to generate virtual fault samples by using a trained generative adversarial network;

a training data set module 4, configured to add the virtual fault samples to the actually collected samples to obtain a new training data set;

a classifier training module 5, configured to train a classifier based on the new training data set; and

a detection and diagnosis module 6, configured to conduct fault detection and diagnosis on a trained classifier.

The following describes in details an application effect of the present invention with reference to an experiment.

In this experiment, normal data and tooth missing fault data of a rotary machine are selected. First, missing fault samples are used as network input. A generative model is used to generate virtual fault samples. A discrimination model is used to distinguish an authentic fault sample and a virtual fault sample, and when an error probability of the discrimination model reaches approximately 0.5, a training process ends. In other words, virtual fault data whose authenticity is difficult to determine is generated. Then, a BP neural network is used for classification. Each sample selected is 1000*1. A feature of each sample is extracted after Fourier transform of the sample, to change each sample to 1*28.

A first group includes selected normal data including 21 normal samples and 3 fault samples. Accuracy of classification using a BP neural network is 0.7500.

A second group includes selected normal data and virtual fault data that is generated by using a generative adversarial network, in which there are 12 normal samples, 6 fault samples, and 6 virtual fault samples. Accuracy of classification using a BP neural network is 0.9583.

| | | Normal data + fault |
|---|---|---|
| | | data generated by using |
| BP neural network | Normal data | the GAN |
| Accuracy | 0.7500 | 0.9583 |

All or some of the foregoing embodiments may be implemented by means of software, hardware, firmware, or any combination thereof. When the foregoing embodiments are implemented completely or partially in a form of a computer program product, the computer program product includes one or more computer instructions. When the computer program instructions are loaded and executed on a computer, the procedure or functions according to the embodiments of the present invention are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive Solid State Disk (SSD)), or the like.

The above-mentioned contents are merely preferred embodiments of the present invention, and are not used to limit the present invention, and wherever within the spirit and principle of the present invention, any modifications, equivalent replacements, improvements and the like shall be all contained within the scope of protection of the present invention.

What is claimed is:

1. A fault detection method based on a generative adversarial network, comprising:
using the generative adversarial network to:
learn a statistical law of fault samples and autonomously generate fault samples,
and
balance the numbers of fault samples and normal samples;'
implementing a conventional supervised fault detection method for learning and modeling of new samples.

2. The fault detection method according to claim 1, further comprising:
step 1: collecting samples and adding labels for the samples;
step 2: training the generative adversarial network to generate virtual fault samples;
step 3: generating virtual fault samples by using the trained generative adversarial network, where a number of the generated virtual fault samples is equal to a difference between a number of normal samples and the number of fault samples;
step 4: adding the virtual fault samples to actually collected samples to obtain a new training data set;
step 5: training a classifier based on the new training data set; and
step 6: conducting fault detection and diagnosis by using the trained classifier.

3. The fault detection method according to claim 2, wherein in step 2, fault samples are used as a network input; a generative model is used to generate virtual fault samples; a discrimination model is used to distinguish an authentic fault sample and a virtual fault sample; and when an error probability of the discrimination model reaches 0.5, a training process ends.

4. A fault detection system based on a generative adversarial network for implementing the fault detection method based on a generative adversarial network according to claim 1, wherein the fault detection system based on a generative adversarial network comprises:
a sample collection module configured to collect samples and add labels for the samples;
a training module configured to train a generative adversarial network to generate virtual fault samples;
a virtual fault sample module configured to generate virtual fault samples by using a trained generative adversarial network;
a training data set module configured to add the virtual fault samples to the actually collected samples to obtain a new training data set;
a classifier training module configured to train a classifier based on the new training data set; and
a detection and diagnosis module configured to conduct fault detection and diagnosis on a trained classifier.

5. A computer program for implementing the fault detection method based on a generative adversarial network according to claim 1.

6. A computer program for implementing the fault detection method based on a generative adversarial network according to claim 2.

7. A computer program for implementing the fault detection method based on a generative adversarial network according to claim 3.

8. An information data processing terminal for implementing the fault detection method based on a generative adversarial network according to claim 1.

9. An information data processing terminal for implementing the fault detection method based on a generative adversarial network according to claim 2.

10. An information data processing terminal for implementing the fault detection method based on a generative adversarial network according to claim 3.

11. A non-transitory computer readable storage medium, comprising an instruction, wherein when the instruction is run on a computer, the computer is enabled to implement the fault detection method based on a generative adversarial network according to claim 1.

12. A non-transitory computer readable storage medium, comprising an instruction, wherein when the instruction is run on a computer, the computer is enabled to implement the fault detection method based on a generative adversarial network according to claim 2.

13. A non-transitory computer readable storage medium, comprising an instruction, wherein when the instruction is run on a computer, the computer is enabled to implement the fault detection method based on a generative adversarial network according to claim 3.
